(19) United States
(12) Patent Application Publication
(10) Pub. No.: US 2008/0170618 A1
(43) Pub. Date: Jul. 17, 2008

(54) METHOD AND APPARATUS FOR ENCODING AND DECODING MULTI-VIEW IMAGES

(75) Inventors: Jong-bum CHOI, Yangju-si (KR); Woo-sung SHIM, Yongin-si (KR); Hak-sup SONG, Suwon-si (KR); Young-ho MOON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/972,971

(22) Filed: Jan. 11, 2008

Related U.S. Application Data
(60) Provisional application No. 60/884,474, filed on Jan. 11, 2007.

(30) Foreign Application Priority Data
May 4, 2007 (KR) 10-2007-0043796

(51) Int. Cl. H04N 7/26

(52) U.S. Cl. 375/240.16; 375/E07.125

(57) ABSTRACT

Provided are a method and apparatus for encoding and decoding multi-view images. The multi-view image encoding method includes predicting a motion vector of a current block, based on information indicating a disparity between a current picture to which the current block belongs and a different picture having a view-point which is different from a view-point of the current picture, and encoding the current block in a skip mode based on the predicted motion vector of the current block.

### CROSS-REFERENCE TO RELATED PATENT APPLICATION

This application claims the benefit of Korean Patent Application No. 10-2007-0043796, filed on May 4, 2007 in the Korean Intellectual Property Office, and U.S. Provisional Application No. 60/884,474, filed on Jan. 11, 2007 in the United States Patents and Trademark Office, the disclosures of which are incorporated herein in their entireties by reference.

### BACKGROUND OF THE INVENTION

1. Field of the Invention

Apparatuses and methods consistent with the present invention relate to encoding and decoding multi-view images, and more particularly, to encoding and decoding a current block using inter-view prediction between multi-view images.

2. Description of the Related Art

In multi-view image coding, multi-view images received from a plurality of cameras are compression-encoded using temporal correlation and spatial correlation between the cameras (inter-view).

In temporal prediction using temporal correlation and inter-view prediction using spatial correlation, by estimating a motion of a current picture in units of blocks using one or more reference pictures, an image is predict-encoded.

Also, by searching for a block that is most similar to the current block among reference pictures that are within a predetermined range, and transmitting only residual data between the current block and the most similar block, a data compression rate is improved.

Information for a motion vector representing a relative motion between the current block and the most similar block is encoded and inserted into a bit stream. At this time, if the information for the motion vector is encoded and inserted without any variation into the bit stream, overhead increases, which decreases a compression rate of image data.

Accordingly, by predicting a motion vector of a current block from its peripheral blocks, and encoding and transmitting only a difference between the predicted motion vector and the current block's original motion vector, information for the motion vector is compressed. A method of predicting a motion vector of a current block using its peripheral blocks will be described in more detail with reference to FIGS. 1A through 1D.

FIGS. 1A through 1D are views for explaining a method of predicting a motion vector, according to a related art technique, wherein the motion vector prediction method is based on the H.264 standard.

FIG. 1A illustrates a case where a motion vector of a current block 110 is predicted when the current block 110 and its peripheral blocks 121, 122, and 123 have the same size. In this case, according to the H.264 standard, a predicted motion vector of the current block 110 is determined by calculating a median value of predicted motion vectors mvA, mvB, and mvC of the peripheral blocks 121, 122, and 123. Since blocks adjacent to a certain block are apt to have similarity, the motion vector of the current block 110 is determined as a median value of motion vectors mvA, mvB, and mvC of the peripheral blocks 121, 122, and 123.

FIG. 1B illustrates a case where a motion vector of a current block 110 is predicted when the current block 110 and its peripheral blocks 131, 132, and 133 have different sizes. In this case, as illustrated in FIG. 1B, a median value of motion vectors of a block 131 at the top of blocks to the left of the current block 110, the left most block 132 of blocks to the top of the current block 110, and the block 133 immediately to the upper right of the current block 110, is determined as a predicted motion vector of the current block 110.

FIG. 1C illustrates a case where a current block 111 or 112 is not a square block. In FIG. 1C, the current block 111 or 112 is an 8×16 block.

If a current block is a block 111, a motion vector of a block 141 to the left of the block 111 is determined as a predicted motion vector of the current block 111. If a current block is a block 112, a motion vector of a block 142 immediately to the upper right of the current block 112 is determined as a predicted motion vector of the current block 112.

FIG. 1D illustrates a case where a current block 113 or 114 is not a square block. In FIG. 1D, the current block 113 or 114 is a 16×8 block.

If a current block is a block 113, a motion vector of a block 151 to the left of the current block 113 is determined as a predicted motion vector of the current block 113. If a current block is a block 114, a motion vector of a block 152 at the top of the current block 114 is determined as a predicted motion vector of the current block 114.

As illustrated in FIGS. 1A through 1D, a predicted motion vector of a current block is determined from motion vectors of its peripheral blocks. The motion vector prediction method predicts a motion vector of a current block using a similarity between blocks adjacent to the current block.

However, when the motion vector prediction method according to the H.264 standard is applied to encoding of multi-view images, the following problem is generated. For example, if the blocks 121, 122, and 123 adjacent to the current block 110 illustrated in FIG. 1A are encoded using temporal prediction, the motion vectors of the blocks 121, 122, and 123 represent temporal correlation of the blocks 121, 122, and 123. If the current block 110 is encoded using inter-view prediction instead of temporal prediction, a motion vector of the current block 110 becomes a motion vector representing inter-view spatial correlation. Accordingly, a motion vector of a current block representing inter-view spatial correlation will have no correlation with a predicted motion vector of the current vector which is predicted from the motion vectors of blocks adjacent to the current vector.

### SUMMARY OF THE INVENTION

The present invention provides multi-view image encoding and decoding methods and apparatuses, capable of predicting a motion vector of a current block using temporal and spatial correlation of multi-view images, and encoding the current block using the motion vector of the current block, and a computer-readable recording medium having embodied thereon a program for executing the multi-view image encoding and decoding methods.

According to an aspect of the present invention, there is provided a method of encoding multi-view images, including: predicting a motion vector of a current block, on the basis of information regarding a disparity between a current picture to which the current block belongs, and a different picture having a view-point which is different from a view-point of the current picture; and encoding the current block on the basis of the predicted motion vector of the current block.

The information regarding the disparity is a global disparity vector representing a global disparity between the current picture and the different picture.

The predicting of the motion vector of the current block includes: predicting the global disparity vector as the predicted motion vector of the current block; and selecting a block corresponding to the current block from blocks of the different picture, on the basis of the predicted motion vector of the current block.

The encoding of the current block includes encoding the current block in a skip mode on the basis of the predicted motion vector of the current block and the selected block.

According to another aspect of the present invention, there is provided an apparatus for encoding multi-view images, including: a prediction unit predicting a motion vector of a current block, on the basis of information regarding a disparity between a current picture to which the current block belongs and a different picture having a view-point which is different from a view-point of the current picture; and an encoding unit encoding the current block on the basis of the predicted motion vector of the current block.

According to another aspect of the present invention, there is provided a method of decoding multi-view images, including: receiving a bit stream including data regarding a current block, and extracting information regarding a disparity between a current picture to which the current block belongs and a different picture having a view-point which is different from a view-point of the current picture, from the bit stream; predicting a motion vector of the current block on the basis of the extracted information; and restoring the current block on the basis of the predicted motion vector of the current block.

According to another aspect of the present invention, there is provided an apparatus for decoding multi-view images, including: a decoding unit receiving a bit stream including data regarding a current block, and extracting information regarding a disparity between a current picture to which the current block belongs and a different picture having a view-point which is different from a view-point of the current picture, from the bit stream; a prediction unit predicting a motion vector of the current block on the basis of the extracted information; and a restoring unit restoring the current block on the basis of the predicted motion vector of the current block.

According to another aspect of the present invention, there is provided a computer-readable recording medium having embodied thereon a program for executing the multi-view image encoding and decoding method.

### BRIEF DESCRIPTION OF THE DRAWINGS

The above and other aspects of the present invention will become more apparent by describing in detail exemplary embodiments thereof with reference to the attached drawings in which:

FIGS. 1A through 1D are views for explaining a motion vector prediction method according to a related art technique;

FIG. 2 is a block diagram of a multi-view image encoding apparatus according to an exemplary embodiment of the present invention;

FIG. 3 is a view for explaining a global disparity vector according to an exemplary embodiment of the present invention;

FIG. 4 illustrates a syntax representing a skip mode according to an embodiment of the present invention;

FIG. 5 is a flowchart of a multi-view image encoding method according to an exemplary embodiment of the present invention;

FIG. 6 is a block diagram of a multi-view image decoding apparatus according to an exemplary embodiment of the present invention;

FIG. 7 is a flowchart of a decoding mode determining method according to an exemplary embodiment of the present invention; and

FIG. 8 is a flowchart of a multi-view image decoding method according to an exemplary embodiment of the present invention.

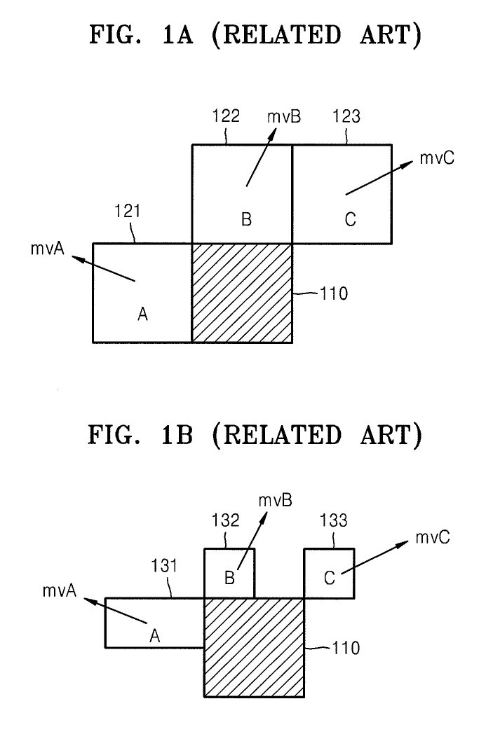

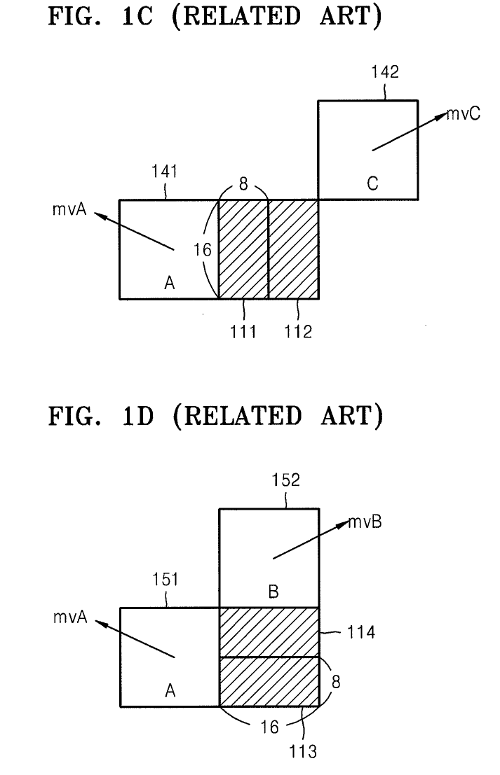

### DETAILED DESCRIPTION OF EXEMPLARY EMBODIMENTS OF THE PRESENT INVENTION

Hereinafter, exemplary embodiments of the present invention will be described in detail with reference to the appended drawings.

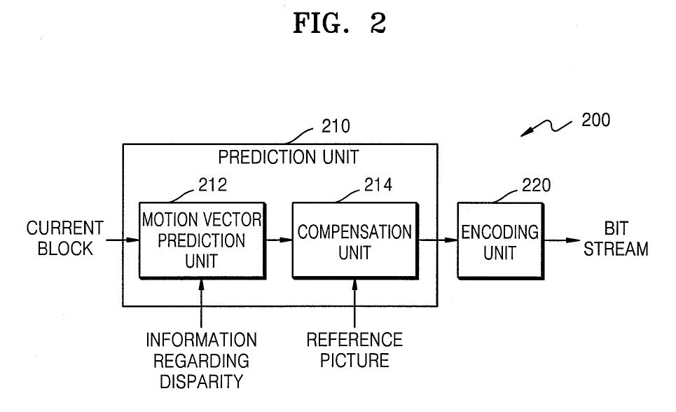

FIG. 2 is a block diagram of a multi-view image encoding apparatus 200 according to an exemplary embodiment of the present invention. The multi-view image encoding apparatus 200 includes a prediction unit 210 and an encoding unit 220.

The prediction unit 210 predicts a motion vector of a current block, on the basis of information regarding a disparity between a current picture to which the current block belongs and a different picture which has a view-point different from the view-point of the current block and is referred to with respect to the current picture for inter-view prediction.

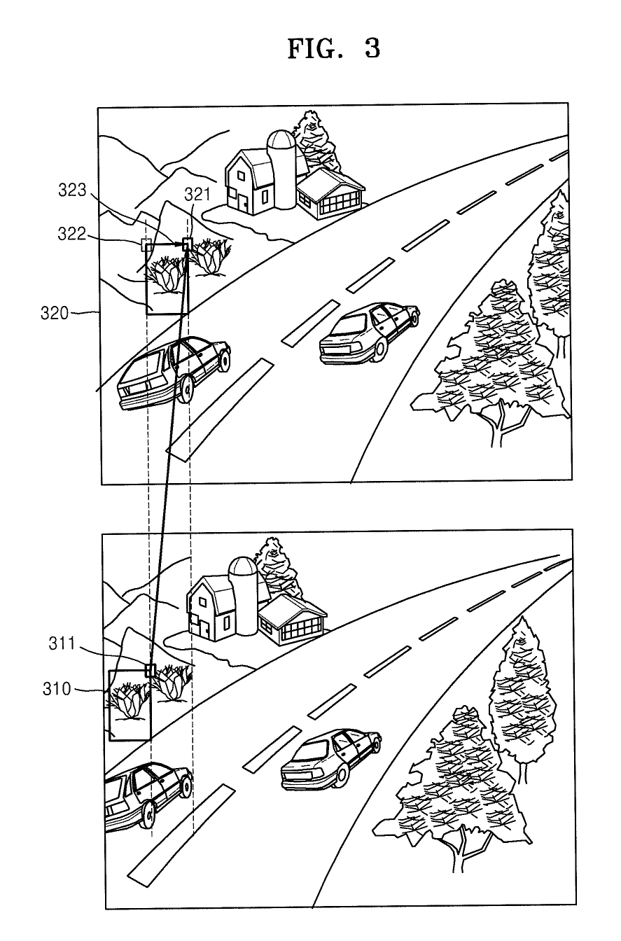

In multi-view image encoding, inter-view prediction is performed with reference to pictures that are generated with respect to different view-points at the same time. Accordingly, spatial correlation exists between a current picture and a different view-point picture for the same object at the same time. In order to use such spatial correlation to encode a current block, the prediction unit 210 predicts a motion vector of the current block on the basis of information regarding a disparity between the current picture and the different view-point picture. The information regarding the disparity will be described in detail with reference to FIG. 3, below.

FIG. 3 is a view for explaining a global disparity vector according to an exemplary embodiment of the present invention.

Referring to FIG. 3, in order to encode a current block 311 of a current picture 310, spatial correlation between the current picture 310 and a different picture 320 which is generated at the same time as the current picture and has a view-point different from a view-point of the current picture 310, is used.

Referring to the two pictures 310 and 320 having different view-points as illustrated in FIG. 3, the different view-point picture 320 will be a picture resulting from shifting of the current picture 310 to the right. A disparity between the current picture 310 and the different view-point picture 320 is generated since the two pictures 310 and 320 have been photographed at the same time by two cameras which are positioned at different locations.

In more detail, the current block 311, which is located at a corner of a picture frame in the current picture 310, corresponds to a block 321 which is located at a corner of a picture frame in the different view-point picture 320.

Accordingly, comparing the location of the current block 311 with the location of the corresponding block 321 of the different view-point picture 320, a disparity vector 323 representing a location difference between the two blocks 311 and 321 can be calculated. In multi-view image encoding, such a disparity vector generated between pictures having different view-points is called “a global disparity vector”.

If the multi-view image encoding apparatus 200 illustrated in FIG. 2 is applied to the case illustrated in FIG. 3, the prediction unit 210 predicts a motion vector of the current block 311 using a disparity which is generated between the pictures 310 and 320 having different view-points. Here, the motion vector of the current block 311 is used for inter-view prediction of the current block 311.

The prediction unit 210 includes a motion vector prediction unit 212 and a compensation unit 214.

The motion vector prediction unit 212 predicts a motion vector of the current block 311 on the basis of information regarding the disparity between the current picture 310 and the different view-point picture 320. Unlike the related art technique in which a motion vector of a current block is predicted from its peripheral blocks, a motion vector of the current block 311 is predicted on the basis of the information regarding the disparity between the current picture 310 and the different view-point picture 320. If the information regarding the disparity is a global disparity vector, the global disparity vector becomes a predicted motion vector of the current block 311.

Since the motion vector of the current block 311 is predicted on the basis of the information regarding the disparity between the current picture 310 and the different view-point picture 320 which is referred to for inter-view prediction, the motion vector of the current block 311 can be more accurately predicted rather than a case of encoding the current block 311 using conventional inter-view prediction.

The compensation unit 214 selects a block corresponding to the current block 311 from blocks of the different view-point picture 320, on the basis of the predicted motion vector of the current block 311. If the predicted motion vector of the current block 311 is a global disparity vector, a block 321 corresponding to the current block 311 is selected from blocks of the different view-point picture 320 according to the global disparity vector.

The encoding unit 220 encodes the current block on the basis of the predicted motion vector of the current block 311.

Also, the encoding unit 220 encodes only a difference between the predicted motion vector of the current block 311 and an original motion vector of the current block 311.

If the current block 311 is encoded using inter-view prediction, the motion vector of the current block 311 is accurately predicted, rather than predicting a motion vector of the current block 311 according to the conventional technique, and accordingly, a disparity value is reduced and a compression rate of encoding is improved. The block 321 corresponding to the current block 311 is generated by searching for blocks of the different view-point picture 320 using the pixel values of the current block 311, and a residual block is generated by subtracting the pixel values of the block 321 from the pixel values of the current block 311. Then, a discrete cosine transform (DCT) is performed on the residual block to convert the residual block into the frequency domain, quantization and entropy-encoding are performed on the resultant residual block, and then the resultant data is inserted into a bit stream.

According to an exemplary embodiment of the present invention, the encoding unit 220 can encode the current block 311, on the basis of the predicted motion vector of the current block 311 which is predicted by the motion vector prediction unit 212 on the basis of the information regarding the disparity, and the block 321 corresponding to the current block 311 which is selected by the compensation unit 214.

In this case, the encoding unit 220 encodes the current block 311 in a skip mode. The “skip mode” is a method of encoding only flag information indicating that a current block is encoded without encoding residual data of the current block. In the case where no residual data exists because the block 321 corresponding to the current block 311, which is selected according to the predicted motion vector of the current block 311, is equal to the current block 311, the encoding unit 220 encodes the current block 311 in the skip mode.

In the skip mode, since the block 321 corresponding to the current block 311 is specified using the predicted motion vector of the current block 311, encoding of information regarding the motion vector of the current block 311 is not required. Also, since the block 321 corresponding to the current block 311 is equal to the current block 311 and thus no residual data exists, encoding of such residual data is also omitted. When a small amount of residual data exists, the encoding unit 220 can encode the current block 311 in the skip mode by calculating a rate-distortion (R-D) cost.

The encoding unit 220 provides a new encoding mode of encoding a current block in a skip mode, using a predicted motion vector of the current block, which is predicted on the basis of information regarding a disparity, that is, by using a global disparity vector.

In the new encoding mode, the current block 311 is encoded in the skip mode, by using the predicted motion vector of the current block 311 which is predicted by the global disparity vector, unlike a related art skip mode of predicting a current block using a predicted motion vector of the current block which is predicted from peripheral blocks adjacent to the current block.

Referring to FIGS. 2 and 3, the motion vector prediction unit 212 predicts a motion vector of the current block 311 using the global disparity vector, and the compensation unit 214 selects the block 321 corresponding to the current block 311 from blocks of the different view-point picture 320 on the basis of the predicted motion vector of the current block 311. The encoding unit 220 compares the corresponding block 321 with the current block 311, and encodes the current block 311 in the skip mode if the corresponding block 321 is equal to the current block 311. As described above, when a small amount of residual data is generated due to a small amount of disparity between the current block 311 and the corresponding block 321, the encoding unit 220 can encode the current block 311 in the skip mode by calculating an R-D cost.

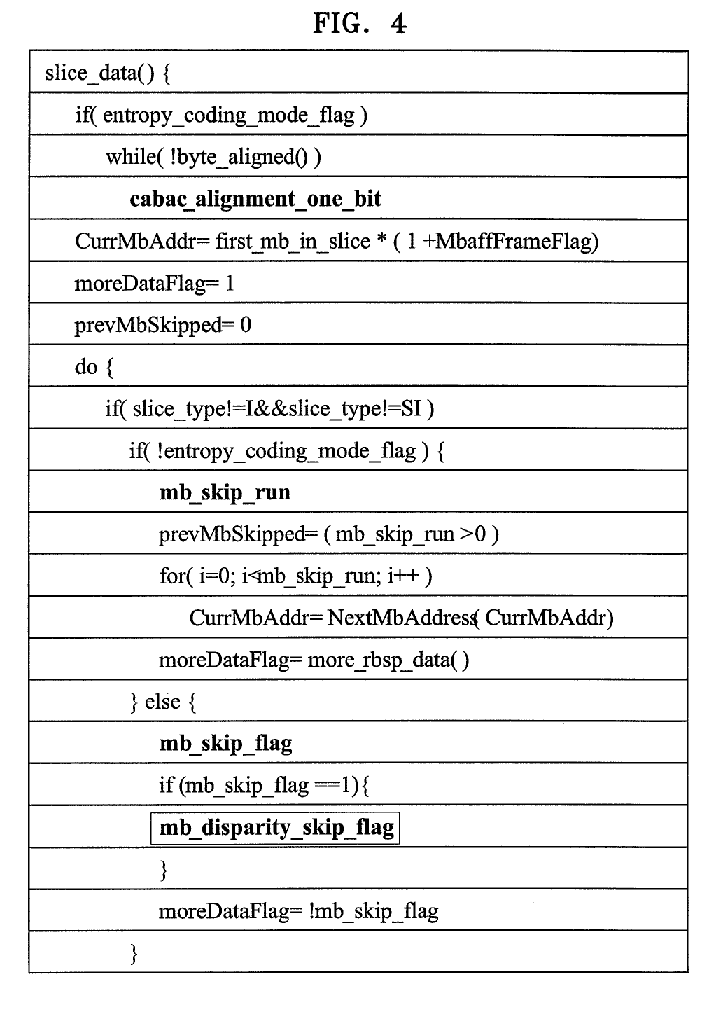

Also, the encoding unit 220 encodes information indicating that the current block 311 is encoded in the skip mode according to an exemplary embodiment of the present invention, and inserts the information into the bit stream. Since the skip mode according to an exemplary embodiment of the present invention has the above-described difference from the conventional skip mode, a new syntax for representing such a difference is needed. The syntax will be described in detail with reference to FIG. 4, below.

FIG. 4 illustrates a syntax for representing a skip mode, according to an exemplary embodiment of the present invention.

Referring to FIG. 4, in order to distinguish the skip mode according to an exemplary embodiment of the present invention from the conventional skip mode, a syntax “mb_disparity_skip_flag” is added to “slice data( )”. That is, a syntax “mb_disparity_skip_flag” indicating the skip mode according to an exemplary embodiment of the present invention, other than a syntax “mb_skip_flag” indicating the conventional skip mode, is added to the “slice_data( )”.

For example, if the syntax “mb_skip_flag” is set to “1” and the syntax “mb_disparity_skip_flag” is set to “0”, this indicates that a current block is encoded in the conventional skip mode. If the syntax “mb_skip_flag” is set to “1” and the syntax “mb_disparity_skip_flag” is set to “1”, this indicates that the current block is encoded in the skip mode according to an exemplary embodiment of the present invention.

If the current block is encoded without using any skip mode, the syntax “mb_skip_flag” is set to “0” and no value is assigned to the syntax “mb_disparity_skip_flag”.

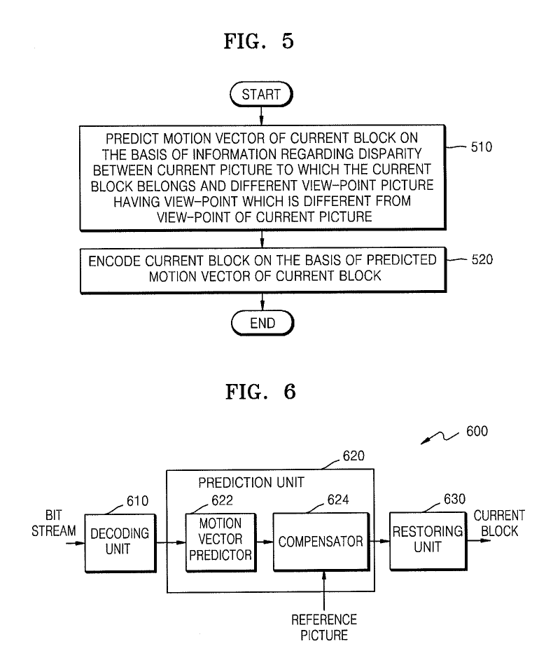

FIG. 5 is a flowchart of a multi-view image encoding method according to an exemplary embodiment of the present invention, wherein the multi-view image encoding method is performed by the multi-view image encoding apparatus 200 illustrated in FIG. 2.

Referring to FIG. 5, in operation 510, a motion vector of a current block is predicted on the basis of information regarding a disparity between a current picture to which the current block belongs and a different view-point picture having a view-point which is different from the view-point of the current picture. The information regarding the disparity may be a global disparity vector. In this case, the global disparity vector becomes a predicted motion vector of the current block.

In operation 520, the current block is encoded on the basis of the predicted motion vector of the current block. The current block may be encoded in the skip mode on the basis of the predicted motion vector of the current block.

FIG. 6 is a block diagram of a multi-view image decoding apparatus according to an exemplary embodiment of the present invention.

Referring to FIG. 6, the multi-view decoding apparatus 600 includes a decoding unit 610, a prediction unit 620, and a restoring unit 630.

The decoding unit 610 receives a bit stream including data regarding a current block, and extracts information regarding a disparity between a current picture to which the current block belongs and a different view-point picture having a view-point which is different from the view-point of the current picture, from the bit stream. The decoding unit 610 may extract information regarding a global disparity vector between the current picture and the different view-point picture, from the bit stream. Also, the decoding unit 610 extracts information indicating an encoding mode used for encoding the current block, from the data regarding the current block. That is, the decoding unit 610 extracts information indicating whether the current block has been encoded in the skip mode according to an exemplary embodiment of the present invention, that is, in a skip mode in which a predicted motion vector of the current block is a global motion vector, from the data regarding the current block. Here, syntaxes including the information regarding the skip mode are “mb_skip_mode” and “mb_disparity_skip_mode” as described above.

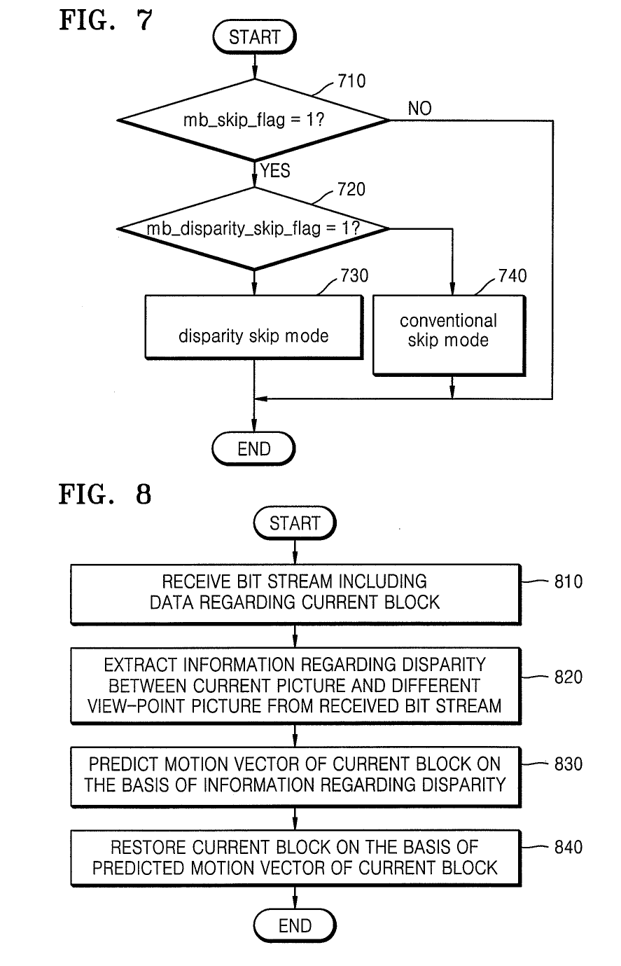

Then, a decoding mode that is to be used for decoding the current block is set on the basis of the extracted information. This operation will be described in detail with reference to FIG. 7, below.

FIG. 7 is a flowchart of a decoding mode determining method according to an embodiment of the present invention, wherein the multi-view image decoding apparatus 600 illustrated in FIG. 6 determines a skip mode when a current block has been encoded according to the syntaxes illustrated in FIG. 4.

In operation 710, it is determined whether the syntax “mb_skip_flag” is set to “1”, with reference to the information regarding the encoding mode which is extracted by the decoding unit 610.

If the syntax “mb_skip_flag” is not set to “1”, it is determined that the current block has been encoded without using any skip mode, and accordingly, the current block is decoded without using any skip mode. Here, the skip mode includes the skip mode according to an exemplary embodiment of the present invention and the conventional skip mode.

If the syntax “mb_skip_flag” is set to “1”, in operation 720, it is determined whether the syntax “mb_disparity_skip_flag” is set to “1”.

If the syntax “mb_skip_flag” is set to “1”, it is determined that the current block has been encoded in the skip mode. In order to determine whether the skip mode is the conventional skip mode or the skip mode according to an exemplary embodiment of the present invention, it is determined whether the syntax “mb_disparity_skip_flag” is set to “1”.

If the syntax “mb_disparity_skip_flag” is set to “1”, it is determined that the current block has been encoded in the skip mode according to an exemplary embodiment of the present invention, that is, in the skip mode in which a predicted motion vector of the current block is a global disparity vector. Accordingly, in operation 730, the current block is decoded in the skip mode according to an exemplary embodiment of the present invention.

If the syntax “mb_disparity_skip_flag” is set to “0’, it is determined that the current block has been encoded in the related art skip mode, that is, in the skip mode in which a predicted motion vector of the current block is predicted from peripheral blocks adjacent to the current block. Accordingly, in operation 740, the current block is decoded in the related art skip mode.

Returning to FIG. 6, the prediction unit 620 predicts a motion vector of the current block on the basis of the information regarding the disparity between the current picture and the different view-point picture having the view-point different from the view-point of the current picture. In detail, the prediction unit 620 predicts a motion vector of the current block on the basis of the information regarding the disparity between the current picture and the different-view point picture which is referred to with respect to the current picture for inter-view prediction, differently from the conventional technique of predicting a motion vector of the current block from previously decoded blocks adjacent to the current block.

The prediction unit 620 may include a motion vector predictor 622 and a compensator 624. The motion vector predictor 622 predicts a motion vector of the current block 311 on the basis of the information regarding the disparity between the pictures having different view-points, which is extracted by the decoding unit 610. If the information regarding the disparity is a global disparity vector, the global disparity vector becomes a predicted motion vector of the current block.

The compensator 624 selects a block corresponding to the current block from blocks of the different view-point picture, on the basis of the predicted motion vector of the current block.

The restoring unit 630 restores the current block on the basis of the predicted motion vector of the current block. The restoring unit 630 adds a disparity value (that is extracted from a received bit stream) between an original motion vector of the current block and the predicted motion vector of the current block to the predicted motion vector of the current block, and thus restores a motion vector of the current block. The restoring unit 630 searches for a different view-point picture according to the restored motion vector of the current block, and selects a predicted block corresponding to the current block from blocks of the different view-point picture. Then, the restoring unit 630 adds a residual block to the predicted block, and restores the current block.

According to an exemplary embodiment of the present invention, if the current block has been encoded in the skip mode according to the present invention, that is, in the skip mode in which a predicted motion vector of the current block is a global disparity vector, the current block is also restored in the skip mode according to the present invention. In this case, the block, which is selected by the compensator 624 on the basis of the predicted motion vector of the current block predicted by the motion vector predictor 622, is restored as the current block.

FIG. 8 is a flowchart of a multi-view image decoding method according to an exemplary embodiment of the present invention, wherein the multi-view image decoding method is performed by the multi-view image decoding apparatus 600 illustrated in FIG. 6.

Referring to FIG. 8, in operation 810, a bit stream including data regarding a current block is received. The data regarding the current block includes information regarding a disparity between a current picture to which the current block belongs and a different view-point picture which is referred to with respect to the current block for inter-view prediction. Also, the data regarding the current block includes information indicating that the current block has been encoded in the skip mode according to an exemplary embodiment of the present invention, that is, in the skip mode in which a predicted motion vector of the current block is a global disparity vector.

In operation 820, the information regarding the disparity between the current picture and the different view-point picture is extracted from the bit stream received in operation 810. The information regarding the disparity may be a global disparity vector.

In operation 830, a motion vector of the current block is predicted on the basis of the information regarding the disparity. If the information regarding the disparity is a global disparity vector, the global disparity vector becomes a predicted motion vector of the current block.

In operation 840, the current block is restored on the basis of the predicted motion vector of the current block. A disparity value between the predicted motion vector of the current block and an original motion vector of the current block is added to the predicted motion vector of the current block to restore a motion vector of the current block, and the current block is restored on the basis of the restored motion vector of the current block. The current block may preferably be restored in the skip mode according to the present invention using the predicted motion vector of the current block. A block corresponding to the current block is selected from blocks of a different view-point picture on the basis of the predicted motion vector of the current block, and the corresponding block is restored as the current block.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiments of the present invention, since a motion vector of a current block is predicted on the basis of information regarding a disparity between a current picture to which the current block belongs and a different block having a view-point which is different from the view-point of the current block, the motion vector of the current block can be predicted correctly more than when the current block is encoded by using conventional inter-view prediction.

Also, by providing a new encoding mode of encoding a current block in a skip mode on the basis of a correctly predicted motion vector of the current block, the probability of encoding a current block in the skip mode increases, which can improve a compression rate of image encoding.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding multi-view images, the method comprising:
predicting a motion vector of a current block, based on information regarding a disparity between a current picture to which the current block belongs, and a different picture having a view-point which is different from a view-point of the current picture; and
encoding the current block based on the predicted motion vector of the current block.

2. The method of claim 1, wherein the information regarding the disparity is a global disparity vector representing a global disparity between the current picture and the different picture.

3. The method of claim 2, wherein the predicting the motion vector of the current block comprises:
predicting the global disparity vector as the predicted motion vector of the current block; and
selecting a block corresponding to the current block from blocks of the different picture, based on the predicted motion vector of the current block.

4. The method of claim 3, wherein the encoding the current block comprises encoding the current block based on the predicted motion vector of the current block and the selected block.

5. The method of claim 3, wherein the encoding the current block comprises encoding the current block in a skip mode based on the predicted motion vector of the current block and the selected block.

6. The method of claim 5, wherein the encoding the current block further comprises encoding information indicating that the current block is encoded in a skip mode based on the predicted motion vector of the current block and the selected block.

7. An apparatus for encoding multi-view images, the apparatus comprising:
a prediction unit which predicts a motion vector of a current block, based on information regarding a disparity between a current picture to which the current block belongs and a different picture having a view-point which is different from a view-point of the current picture; and
an encoding unit which encodes the current block based on the predicted motion vector of the current block.

8. The apparatus of claim 7, wherein the information regarding the disparity is a global disparity vector representing a global disparity between the current picture and the different picture.

9. The apparatus of claim 8, wherein the prediction unit comprises:
a motion vector prediction unit which predicts the global disparity vector as the predicted motion vector of the current block; and
a compensation unit which selects a block corresponding to the current block from blocks of the different picture, based on the predicted motion vector of the current block.

10. The apparatus of claim 9, wherein the encoding unit encodes the current block based on the predicted motion vector of the current block and the selected block.

11. The apparatus of claim 9, wherein the encoding unit encodes the current block in a skip mode, based on the predicted motion vector of the current block and the selected block.

12. The apparatus of claim 11, wherein the encoding unit encodes information indicating that the current block is encoded in the skip mode based on the predicted motion vector of the current block and the selected block.

13. A method of decoding multi-view images, the method comprising:
receiving a bit stream including data regarding a current block;
extracting from the bit stream information regarding a disparity between a current picture to which the current block belongs and a different picture having a view-point which is different from a view-point of the current picture;
predicting a motion vector of the current block based on the extracted information; and
restoring the current block based on the predicted motion vector of the current block.

14. The method of claim 13, wherein the information regarding the disparity is a global disparity vector representing a global disparity between the current picture and the different picture.

15. The method of claim 14, wherein the predicting the motion vector of the current block comprises:
predicting the global disparity vector as the predicted motion vector of the current block; and
selecting a block corresponding to the current block from blocks of the different picture, based on the predicted motion vector of the current block.

16. The method of claim 15, wherein the restoring the current block comprises restoring the current block based on the predicted motion vector of the current block and the selected block.

17. The method of claim 15, wherein the restoring the current block comprises restoring the current block in a skip mode based on the predicted motion vector of the current block and the selected block.

18. An apparatus for decoding multi-view images, the apparatus comprising:
a decoding unit which receives a bit stream including data regarding a current block;
extracting from the bit stream information regarding a disparity between a current picture to which the current block belongs and a different picture having a view-point which is different from a view-point of the current picture;
a prediction unit which predicts a motion vector of the current block based on the extracted information; and
a restoring unit which restores the current block based on the predicted motion vector of the current block.

19. The apparatus of claim 18, wherein the information regarding the disparity is a global disparity vector representing a global disparity between the current picture and the different picture.

20. The apparatus of claim 19, wherein the prediction unit comprises:
a motion vector prediction unit which predicts the global disparity vector as the predicted motion vector of the current block; and
a compensating unit which selects a block corresponding to the current block from blocks of the different picture, based on the predicted motion vector of the current block.

21. The apparatus of claim 20, wherein the restoring unit restores the current block, based on the predicted motion vector of the current block and the selected block.

22. The apparatus of claim 20, wherein the restoring unit restores the current block in a skip mode based on the predicted motion vector of the current block and the selected block.

23. A computer-readable recording medium having embodied thereon a program for executing the method of claim 13.
